(19) United States
(12) Patent Application Publication
(10) Pub. No.: US 2022/0178793 A1
(43) Pub. Date: Jun. 9, 2022

(54) Mold Testing System

(71) Applicant: Thomas Re, Murrells Inlet, SC (US)

(72) Inventor: Thomas Re, Murrells Inlet, SC (US)

(21) Appl. No.: 17/544,013

(22) Filed: Dec. 7, 2021

Related U.S. Application Data
(60) Provisional application No. 63/122,130, filed on Dec. 7, 2020.
(60) Provisional application No. 63/155,945, filed on Mar. 3, 2021.

(51) Int. Cl. G01N 1/24; H04N 5/225; H04N 5/232; G02B 21/34

(52) U.S. Cl. CPC G01N 1/24; H04N 5/2256; G02B 21/34; H04N 5/232; H04N 5/2252

(57) ABSTRACT

This present invention relates to a comprehensive mold testing system capable of capturing high-resolution photographs of mold samples and wirelessly sending the digital photographs to a remote location for analysis. The mold testing system includes a vacuum-based mold capturing device and a smartphone application. The vacuum-based mold capturing device features a vacuum pump, a high-resolution/magnification camera, and a wireless communication module. The wireless communication module transmits the captured images wirelessly to the smartphone application, and the smartphone application transmits the received images to a mold specialist for testing, analysis and expert advice. The mold sample testing system eliminates the need to physically submit the mold samples to a testing laboratory, and provides a quicker turnaround time for receiving the results of the mold analysis.

### CROSS-REFERENCE TO RELATED APPLICATION

The present application claims priority to, and the benefit of, U.S. Provisional Application No. 63/122,130, which was filed on Dec. 7, 2020 and U.S. Provisional Application No. 63/155,945, which was filed on Mar. 3, 2021 both of which are incorporated herein by reference in their entirety.

### FIELD OF THE INVENTION

The present invention relates generally to the field of mold inspection. More specifically, the present invention relates to a comprehensive mold sample testing system that enables rapid testing and detection of mold in a convenient manner. The novel mold testing system includes an internal vacuum pump that is designed to suction air samples, which may contain mold spores. As air is drawn into the device, any mold spores present in the air sample are collected on a slide, which is further photographed by a high-resolution digital camera that is located inside the device. The digital images of the sample are then sent to a laboratory for further testing via wireless communication over the Internet. The mold testing system provides a convenient and cost-effective mold detection and testing tool, which can provide a rapid turnaround. Accordingly, the present disclosure makes specific reference thereto. Nonetheless, it is to be appreciated that certain aspects of the present invention are also equally applicable to other like applications, devices and methods of manufacture.

### BACKGROUND OF THE INVENTION

By way of background, mold and mildew may be present in homes, schools, offices or other buildings, especially in areas having a damp and/or moist environment. Mold is a type of fungus that consists of small organisms found almost everywhere. Mold typically thrives on moist surfaces, and reproduces by the creation of tiny, lightweight spores that travel through the air. Many types of mold are harmless unless they start growing on damp surfaces inside a building. When the mold is growing on a surface, the mold spores can be released into the air, which can be easily inhaled by occupants of the building. Inhaling mold spores may cause health problems including, without limitation, sneezing, stuffy nose, red or itchy eyes, and various skin conditions. Additionally, in more severe cases, some individuals may experience allergies related to mold and/or asthma, and the mold spores present in the air may lead to a medical emergency for those severely affected by mold.

Specialized equipment is usually needed to detect the presence of mold, and mold inspections are normally completed by a certified and licensed mold inspector, which can be expensive. Current mold testing methods, such as spore trap, swab test, bulk sampling or the like, are typically used to inspect for mold, and normally require the mold inspector to first collect the samples and then send the collected samples to a mold testing laboratory for further analysis.

Another method commonly used for detecting mold is an air sampling pump. An air sampling pump works by collecting an air sample over time and storing it in a plastic cassette or other suitable container. This method of mold detection is commonly used to test indoor air for the presence of various pollutants like mold, asbestos and other fungi. Currently, air sample testing relies on sending the test sample, which has been collected and stored in a plastic cassette, to a specialized laboratory for analysis. The plastic testing cassette is frequently shipped using express shipment means so that the sample will arrive at the laboratory in a timely manner. Express shipments can be costly and may require special handling to avoid extreme temperatures during transit, which may affect the laboratory results of the air sample.

Further, once the air sample has been received by the laboratory, the plastic housing of the cassette is discarded since it is not currently practical to re-use the same. The next step in the process is to transfer any mold that may be present in the air sample to a slide so that it can be analyzed by the laboratory technician under a microscope. The laboratory inspection process including testing, analyzing and reporting the test results to the environmental professional usually takes between two to four days to complete. Accordingly, the mold testing processes currently being used by environmental professionals is inefficient at best in terms of both resources and time, and in some instances wasteful.

Therefore, there exists a long felt need in the art for a novel mold testing system that can collect and detect a mold sample with a rapid turnaround time. There is also a long felt need in the art for a mold testing system that does not require the sample to be physically shipped to a mold testing laboratory, which can be both time consuming and expensive, and may lead to the sample becoming lost, compromised or damaged during transit. Additionally, there is a long felt need in the art for a mold testing system that eliminates the reliance on plastic cassettes for collecting and storing air samples, and that does not require express shipping and/or special handling of the air samples to ensure proper delivery to the laboratory. Finally, there is a long felt need in the art for a mold testing system that is cheaper and easier to complete as compared to the currently available mold testing methods and systems.

The subject matter disclosed and claimed herein, in one embodiment thereof, comprises a unique and portable air collection and mold detection device that utilizes a vacuum-based testing system for mold sampling. The device is comprised of an internal vacuum pump for collecting an ambient air sample, a glass slide or cassette upon which the mold spores are accumulated, a high-resolution digital camera for taking one or more photographic images of any mold spores that have accumulated on the slide, and a wireless communication module for data transmission between a remote device, such as a smartphone using a customized application module, and the novel portable mold collection and detection device. The portable mold collection and detection device may also comprise a hinged lid, which can be left open when the device is actively collecting the air sample and when taking the photographic images of the potential mold samples. The hinged lid also serves to protect the delicate components of the device when the same is not in use.

In this manner, the novel mold testing system of the present invention accomplishes all of the forgoing objectives, and provides a relatively quick, easy and cost-effective solution to collecting, testing and analyzing mold samples. The mold testing system of the present invention is also easy to use and reduces the necessity of having mold inspectors onsite to perform the test. Additionally, the mold testing system simplifies the process of collecting mold samples and sending the same to the laboratory for analysis, wherein the user is no longer required to physically ship the samples to the laboratory.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a unique and portable air collection and mold detection device that utilizes a vacuum-based testing system for mold sampling. The device is comprised of an internal vacuum pump for collecting an ambient air sample, a glass slide or cassette upon which the mold spores are accumulated, a high-resolution digital camera for taking one or more photographic images of any mold spores that have accumulated on the slide, and a wireless communication module for data transmission between a remote device, such as a smartphone using a customized application module, and the novel portable mold collection and detection device. The portable mold collection and detection device also has a hinged lid, which can be open when the mold collection and detection device is actively collecting an air sample and when taking the photographic images of the potential mold samples. The lid also serves to protect the delicate components of the device from damage when it is not in use.

In a further embodiment of the present invention, a complete mold sample testing system that eliminates the requirement of sending physical mold samples to a laboratory for analysis is disclosed. The novel stand-alone mold sampling testing system comprises a mold sample testing device and a software application installed on an electronic device. The mold sample testing device wirelessly communicates with the software application and further comprises an internal vacuum pump for suctioning ambient air through vacuum openings present at the top of the device, a glass slide or cassette to accumulate mold air sample pulled by the vacuum pump, a high-resolution digital camera equipped with an LED light ring for capturing one or more high resolution photographic images of the collected mold spores, a wireless communication module to transmit the one or more high resolution photographic images to the software application for testing, a memory to store the digital images/photographs of the mold spores, a USB charging port for charging rechargeable batteries that are used to power the device, and a control button to switch the device on/off. The software application can send the received mold images from the mold sample testing device to a mold inspector, environmental professional or the like through a public network such as the Internet for testing and analysis, thereby replacing the standard physical method of testing for mold.

In yet another embodiment of the present invention, a mold sample testing system for submitting digital and high-resolution photographic images of collected mold samples for laboratory analysis is disclosed. The system comprises a vacuum-based mold analyzing device and a smartphone application. The vacuum-based mold analyzing device is generally cylindrical in shape with a hollow interior body that houses an internal vacuum pump, a glass slide or cassette positioned below the internal vacuum pump to collect the mold samples, a high-resolution microscope camera at the center of the device to magnify and capture images of the mold samples collected on the glass slide or cassette, and a smartphone application in wireless communication to the vacuum-based mold analyzing device and that controls the operation of the vacuum-based mold analyzing device with input controls provided on the interface of the smartphone application. The smartphone application receives the images of the mold samples from the vacuum-based mold analyzing device and transmits the same to a mold inspector, environmental professional or the like through a public network such as the Internet for testing and analysis, thereby replacing the need for standard physical methods of mold testing.

In a further embodiment of the present invention, a method of submitting digital, high-resolution photographs of collected mold spores for laboratory analysis with a rapid turnaround is disclosed. The method comprises the initial step of opening a top lid of a vacuum-based mold analyzing device. The vacuum-based mold analyzing device is then activated using a control button on the device or through a wireless signal sent from a controlling smartphone application, wherein the application is installed on an electronic device and is paired with the vacuum-based mold analyzing device. Next, one or more mold samples is suctioned from the ambient air by an internal vacuum pump of the device, wherein accumulated mold samples are positioned on a cassette or glass slide or petri dish. High resolution microscopic images of the collected mold samples are then captured by a microscopic camera present within the vacuum-based mold analyzing device, and the same are transmitting wirelessly to the smartphone application. Upon receipt, the captured images are then transmitted by the smartphone application to a mold inspector, environmental professional or the like through a public network such as the Internet for testing, analysis and expert advice.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram of one potential embodiment of the novel mold testing system of the present invention in accordance with the disclosed architecture;

FIG. 2 illustrates a block diagram of another potential embodiment of the novel mold testing system of the present invention in accordance with the disclosed architecture;

FIG. 3 illustrates a perspective view of one potential embodiment of the smartphone application used in the mold testing system of the present invention in accordance with the disclosed architecture;

FIG. 4 illustrates a perspective view of one potential embodiment of the mold collection and detection device used in the mold testing system of the present invention in accordance with the disclosed architecture;

FIG. 5 illustrates a partial perspective view of one potential embodiment of the mold collection and detection device shown in FIG. 4 in accordance with the disclosed architecture, wherein the protective lid is an open position;

FIG. 6 illustrates a cut-away perspective view of one potential embodiment of the internal vacuum pump of the mold collection and detection device shown in FIG. 4 in accordance with the disclosed architecture;

FIG. 7 illustrates a perspective view of one potential embodiment of the novel mold testing system of the present invention in accordance with the disclosed architecture, wherein a user is transferring high resolution images of mold spores captured by the mold collection and detection device from his or her smartphone application to a laboratory for analysis; and

FIG. 8 illustrates a flow chart diagram showing the essential procedural steps of one potential method of utilizing the novel mold testing system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

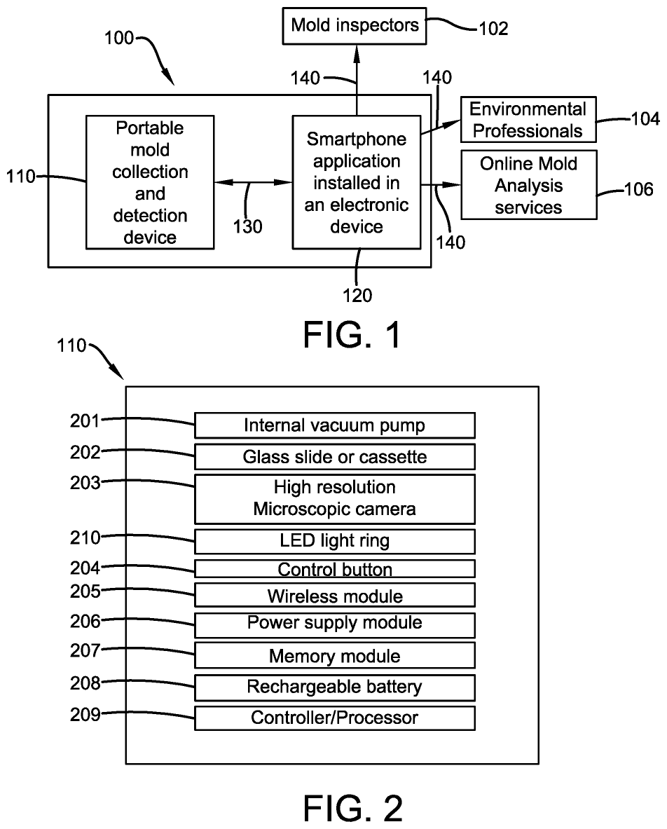

Referring initially to the drawings, FIG. 1 illustrates a block diagram of one potential embodiment of the novel mold testing system 100 of the present invention in accordance with the disclosed architecture. As shown, the mold testing system 100 comprises a portable mold collection and detection device 110 and a companion smartphone application 120 installed on an electronic device. The portable mold collection and detection device 110 and the companion smartphone application 120 are connected to each other through a wireless communication channel 130 such as, but not limited to one of a Wi-Fi, Bluetooth, Zigbee, Wi-Fi Direct, RFID, NFC channel. The companion smartphone application 120 can also be connected by reading a barcode/QR code present on the portable mold collection and detection device 110. The portable mold collection and detection device 110 is controlled by the smartphone application 120 for activation/deactivation of the various components described herein, and the portable mold collection and detection device 110 transmits photographic images of the potential mold samples to the smartphone application 120 through the wireless communication channel 130. Upon receipt, the smartphone application 120 sends the received high resolution photographic images to one or more of a mold inspector 102, an environmental professionals 104, an online mold analysis service 106, or any other laboratory through a communication network 140 for analysis and testing.

It should be appreciated that the smartphone application 120 can be any type of software module installed on an electronic device, such as a smartphone, digital tablet, or other mobile device, that is capable of communicating with the portable collection and detection device 110, and that can further transmit photographic images of potential mold samples to a remote site by e-mail, text messaging, uploading, or can be viewed by accessing online through a web browser. The smartphone application 120 has the additional capability of determining the specific type of mold present by comparing the photographic image taken by the portable collection and detection device 110 to multiple images stored within the smartphone application 120. This feature of the present invention will provide an instant indication to the user about the type and hazards related to the mold sample. The smartphone application 120 can be downloaded from an Appstore that is specific to the mobile device.

FIG. 2 illustrates a block diagram of another potential embodiment of the novel mold testing system 100 of the present invention in accordance with the disclosed architecture. The portable mold collection and detection device 110 is a portable and relatively lightweight device, and comprises an internal vacuum pump 201 that is designed to suction or draw ambient air that may contain mold spores onto a glass slide or cassette 202. It should be noted that the internal vacuum pump 201 is described herein as a vacuum pump; however, a fan could also serve to draw-in the ambient air sample as well. The air sample is preferably collected at a rate of 15 liters per minute by the internal vacuum pump 201. The air sample is collected onto the glass slide or cassette 202, which is located at the top of the portable mold collection and detection device 110 (see e.g., FIGS. 4-6).

The portable mold collection and detection device 110 further comprises a high-resolution digital camera 203 that captures digital photographic images of the potential mold sample taken at a relatively high magnification. More specifically, the high magnification of the digital camera 203 should be similar to that of a microscope, which could be 50× (i.e., 50 times actual size) or 100×. The digital camera 203 is preferably located within the approximate center of the portable mold collection and detection device 110 along with an LED light ring 210. The LED light ring 210 provides the correct amount of light intensity when capturing the photographic images, and can either be automatically or manually adjusted depending on the mold sample.

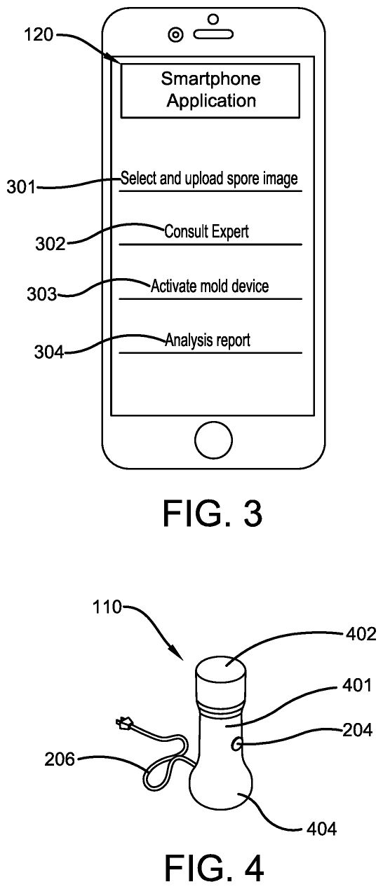

The digital camera 203 and the LED light ring 210 can be activated using the smartphone application 120 (see e.g., FIGS. 1 and 3), or by pressing the control button 204. The control button 204 of the portable mold collection and detection device 110 can also be used to turn on or off the internal vacuum pump 201. A high-resolution photographic image captured by the digital camera 203 is then transmitted to a smartphone, tablet, or other electronic device by a wireless communication module 205, such as a Wi-Fi/Bluetooth SoC embedded in a PCB present within the portable mold collection and detection device 110. Further, a controller/processor 209 controls the various components contained within the portable mold collection and detection device 110 based on input received by a user via the control button 204 and/or smartphone application 120. For example, the smartphone application 120 can transmit instructions to the wireless communication module 205, which is then sent to the controller/processor 209 for controlling the operation of the various components of the portable mold collection and detection device 110.

The novel portable mold collection and detection device 110 further comprises a memory module 207 for storing the several digital images of the mold spores captured by the high-resolution digital camera 203. The memory module 207 may further include a card slot for a standard removable memory card. The portable mold collection and detection device 110 may also comprise a power supply cord 206 for energizing the various components contained therein, and can operate under alternating current (AC) or direct current (DC). In addition, or alternatively, the portable mold collection and detection device 110 may further include a rechargeable battery 208.

FIG. 3 illustrates a perspective view of one potential embodiment of the smartphone application 120 installed on a smartphone 702 and used in the mold testing system 100 of the present invention in accordance with the disclosed architecture. As stated previously, the smartphone application 120 can control the operation of the various components of the portable mold collection and detection device 110, and also communicates with the experts through a communication network 140. The smartphone application 120 can have a plurality of input and output controls to provide an efficient operation and control to the user. Some of the exemplary input controls of the smartphone application 120 are shown in FIG. 3. For example, one such input control button on the smartphone application 120 is “Select and Upload Mold Spore Image” 301 that allows a user to select a mold sample image, which was received from the portable mold collection and detection device 110. Once the mold image is selected and appears on the user's smartphone 702 or other electronic device, the image can be viewed, e-mailed, texted or uploaded to an expert's website. Similarly, the button “Consult Expert” 302 on the novel smartphone application 120 can be used to consult an expert for a detailed discussion on the analysis of the mold sample, which has already been sent to the expert. Yet another button “Activate Mold device” 303 is used to activate and control the portable mold collection and detection 110, including the internal vacuum pump 201, digital camera 203, wireless communication module 205, etc. The button “Analysis report” 304 on the smartphone application 120 allows the user to view the analysis report shared by an expert with respect to the uploaded photographic images. Notwithstanding, it should be appreciated that additional control buttons may also be included on the smartphone application 120.

FIG. 4 illustrates a perspective view of one potential embodiment of the mold collection and detection device 110 used in the mold testing system 100 of the present invention in accordance with the disclosed architecture. The mold collecting and detection device 110 has an outer shell 401, which is generally cylindrical in shape and having a hollow interior. Further, the device 110 includes a lid 402 that is pivotally attached at the top end of outer shell 401, and a base 404 located at the bottom portion of the outer shell 401, which is suitably sized to allow the novel mold collection and detection device 110 to stand upright. The control button 204 is preferably located on the exterior surface of the outer shell 401, and is used for activating and controlling the device 110 as described in relation to FIG. 2 above.

The device 110 may be energized by the power cord 206, which is connected to a power source (not shown). Alternatively, the mold collection and detection device 110 can be powered by an internal rechargeable battery 208 as described above. The mold collection and detection device 110 can also have additional switches located on the exterior surface of the outer shell 401, which can enhance the utility of the device 110. For example, in one embodiment of the present invention, one or more visual and/or audio indicators, such as LED lights or buzzers/speakers, may be present to indicate the status of operation of the mold collection and detection device 110, and also to indicate any fault in its operation.

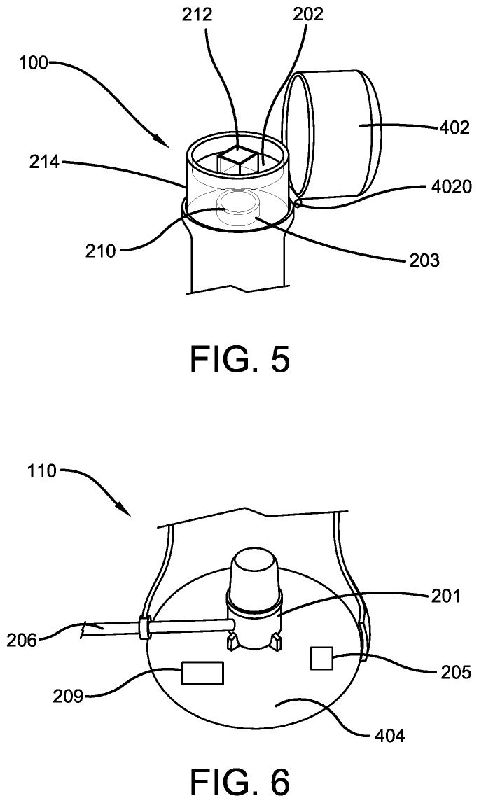

FIG. 5 illustrates a partial perspective view of one potential embodiment of the mold collection and detection device 110 shown in FIG. 4 in accordance with the disclosed architecture, wherein the protective lid 402 is an open position. As shown, the lid 402 is pivotally attached to the outer shell 401 by a hinge 4020. Additionally, when the novel mold collection and detection device 110 is activated or switched on, the LED light ring 210 luminates to provide the proper amount of lighting for the high-resolution digital camera 203 to capture magnified images of potential mold spores in the collected sample of ambient air. The vacuum opening 212 is located above the glass slide or cassette 202 such that when the internal vacuum pump 201 is turned-on, air will be drawn into the internal chamber 214 at a rate of approximately 15 liters per minute and onto the glass slide or cassette 202. Each of the glass slide 202, vacuum opening 212, LED light ring 210, and digital camera 203 may be protected from damage when the device 110 is not being used by closing lid 402. Additionally, the digital camera 203 can automatically turn on when the device 110 is activated, or can be manually activated by pushing the control button 204 or via an instruction received from the smartphone application 120.

FIG. 6 illustrates a cut-away perspective view of one potential embodiment of the internal vacuum pump 201 of the mold collection and detection device 110 shown in FIG. 4 in accordance with the disclosed architecture. As shown, the internal vacuum pump 201 is located within the base 404 of the novel mold collection and detection device 110 for providing air intake at the preferable rate of 15-18 liters per minute. The mold spores are collected onto a glass slide or cassette 202, which is located at the top of the device 110. Also, other essential components such as the wireless module 205, the controller/processor 209, the memory module 207 and the rechargeable battery 208 (if present) are also preferably located in the base 404.

It should be noted that the various components described above and any other optional components are electrically connected to each other by wires that are not shown. As an example, the control button 204 is connected to each of the internal vacuum 201 and the high-resolution digital camera 203. The processor/controller 209 is connected to all of the electronic components to control their operation, and send instruction signals to the various components. The control button 204 that is located on the exterior surface of outer shell 401 can be a push button, a slide button, or a touch-activated switch. Additionally, the novel mold collection and detection device 110 is preferably comprised of a durable yet lightweight plastic material, and has an overall weight of between 1.5 to 2 pounds and overall dimensions of approximately 4×6×10 inches.

In one embodiment of the present invention, the novel mold collection and detection device 110 may include an automatic timer that can be set using the smartphone application 120 for purposes of periodically activating the device 110 so that air samples can be collected over a scheduled period of time. The device 110 is available as an assembled unit, and is preferably designed to be used indoors but may also include additional provisions to make it waterproof for outdoor applications.

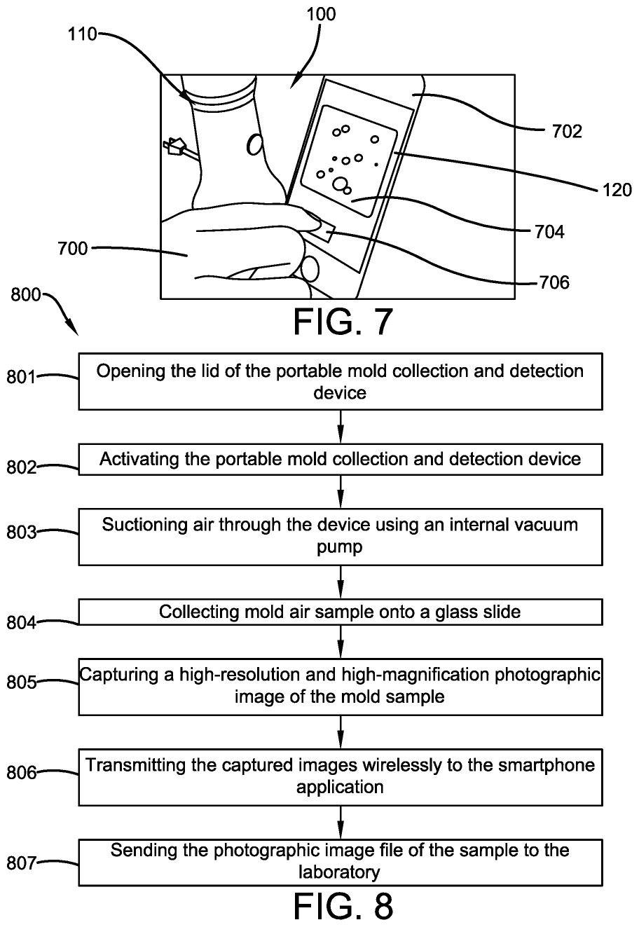

FIG. 7 illustrates a perspective view of one potential embodiment of the novel mold testing system 100 of the present invention in accordance with the disclosed architecture, wherein a user 700 is transferring high resolution images of mold spores captured by the mold collection and detection device 110 from his or her smartphone application 120 to a laboratory for analysis. The novel smartphone application 120 is installed on an electronic device 702 and can receive one or mold spore images 704 of the mold spores captured by the built-in high resolution and high-magnification digital camera 203 of the novel mold collection and detection device 110 through a wireless communication channel, such as Wi-Fi/Bluetooth/Zigbee/Wi-Fi Direct/RFID/NFC. Next, based on an input control 706 by the user 700, the smartphone application 120 can transmit the mold spore image 704 to one or more of a mold inspector 102, an environmental professional 104, or an online mold analysis services 106 for inspection, testing and analysis. The mold spore image 704 can be transmitted in the form of an e-mail, text message, uploaded to a website or sent to a printer.

In another embodiment of the present invention, the expert 102, 104, 106 may have a different version of the smartphone application 120 in which the expert can review and analyze the received mold spore image 704. The use of digital photographic images of the mold spores gives the users of the present invention mold testing system 100 much needed convenience for testing air samples for the presence of mold spores. High resolution microscopic image analysis of the present invention provides a perfect alternative to the conventional method of collecting a sample, physically sending it to a laboratory, and then awaiting for the analysis to be complete, all of which can be time consuming, expensive and may result in the samples being lost in transit or otherwise compromised.

As previously mentioned, the high-resolution images 704 taken by the digital camera 203 are at a magnification level similar to that of a microscope, meaning 50×, 100× or 150×. The images 704 can have any image file format, such as 2088-pixel×1550-pixel, 24-bit, color JPEG (Joint Photographic Experts Group) files, that suits user need and/or preference. Other file formats, such as PNG—Portable Network Graphics, GIF—Graphics Interchange Format, TIFF—Tagged Image File, PSD—Photoshop Document and PDF—Portable Document Format, may also be used.

FIG. 8 illustrates a flow chart diagram 800 showing the essential procedural steps of one potential method of utilizing the novel mold testing system 100 of the present invention in accordance with the disclosed architecture. The steps for operating the novel mold sample testing system 100 include: Step 1—opening the lid of the portable mold collection and detection device (Block 801); Step 2—activating the portable mold collection and detection device (Block 802), either by pressing a control button on the device 110 or through a wireless signal sent from an electronic device that is running the smartphone application wherein the two devices are communicating through a wireless communication channel 130; Step 3—suctioning air through the device 110 using an internal vacuum pump 201 (Block 803); Step 4—collecting mold air samples on a cassette or glass slide 202 (Block 804); Step 5—capturing a high-resolution and high-magnification photographic image 704 of the mold sample (Block 805); Step 6—transmitting the captured images 704 wirelessly to the smartphone application 120 (Block 806); and sending the photographic image file 704 of the sample to the laboratory (Block 807) or the like through a public network for testing, analysis and expert advice.

The system 100 of the present invention allows for the rapid detection of mold spores and other biohazards that, in turn, enable an individual to respond quickly and appropriately to mold related issues. Analysis of microscopic images digitally sent by the individual offer an effective, fast, environment-friendly and cost-effective approach to traditional methods for the identification and analysis of mold spores. The system 100 of the present invention protects individuals from harmful mold and mycotoxins, and can be used anywhere in a home, office or any other enclosed or open space.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mold testing system”, “mold sample testing system”, “mold collection and detection device”, and “vacuum-based mold analyzing device” are interchangeable and refer to the mold testing system 100 of the present invention.

Notwithstanding the forgoing, the mold testing system 100 and its various components of the present invention can be of any suitable size and configuration as is known in the art without affecting the overall concept of the invention, provided that it accomplishes the above stated objectives. One of ordinary skill in the art will appreciate that the size, configuration and material of the mold testing system 100 and its components as shown in the FIGS. are for illustrative purposes only, and that many other sizes, shapes and configurations of the mold testing system 100 are well within the scope of the present disclosure. Although the dimensions of the mold testing system 100 and its various components are important design parameters for user convenience, the mold testing system 100 and its various components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mold testing system comprising:
a portable mold collection device; and
a mobile application in wireless communication with the portable mold collection device.

2. The mold testing system as recited in claim 1, wherein the portable mold collection device comprises a vacuum pump.

3. The mold testing system as recited in claim 2, wherein the portable mold collection device comprises a glass slide or a cassette.

4. The mold testing system as recited in claim 3, wherein the portable mold collection device comprises a digital camera.

5. The mold testing system as recited in claim 4, wherein the portable mold collection device comprises an LED light ring.

6. The mold testing system as recited in claim 5, wherein the portable mold collection device comprises a battery.

7. The mold testing system as recited in claim 6, wherein the portable mold collection device comprises a wireless communication module.

8. The mold testing system as recited in claim 7, wherein the portable mold collection device comprises a control button.

9. The mold testing system as recited in claim 8, wherein the portable mold collection device comprises a processor.

10. The mold testing system as recited in claim 9, wherein the portable mold collection device comprises a memory module.

11. The mold testing system as recited in claim 2, wherein the vacuum pump pulls air at a rate of between 15-18 liters per minute.

12. A method of using a mold testing system comprising the steps of:
opening a lid on a mold collection and detection device;
activating the mold collection and detection device either by pressing a control button on the mold collection and detection device or through a wireless signal sent from an electronic device having a mobile application installed thereon;
using a vacuum pump to gather a mold sample onto a cassette or a glass slide;
capturing a magnified photographic image of the mold sample;
transmitting the magnified photographic images of the mold sample to the mobile application; and
using the mobile application to send the magnified photographic image of the mold sample to a mold specialist.

13. The method of using a mold testing system of claim 12, wherein the mold collection and detection device comprises a digital camera.

14. The method of using a mold testing system of claim 13, wherein the mold collection and detection device comprises an LED light ring.

15. The method of using a mold testing system of claim 14, wherein the mold collection device comprises a battery.

16. The method of using a mold testing system of claim 15, wherein the mold collection device comprises a wireless communication module.

17. The method of using a mold testing system of claim 16, wherein the mold collection device comprises a processor.

18. The method of using a mold testing system of claim 17, wherein the mold collection device comprises a memory module and further wherein the vacuum pump pulls air at a rate of between 15-18 liters per minute.

19. A portable mold collection device comprising:
a housing;
a vacuum pump;
a glass slide or a cassette;
a digital camera;
an LED light ring; and
a wireless communication module.

20. The portable mold collection device of claim 19 further comprising a control button, a processor, and a memory module, wherein the vacuum pump pulls air at a rate of between 15-18 liters per minute.
